(19) United States
(12) Patent Application Publication
(10) Pub. No.: US 2015/0037077 A1
(43) Pub. Date: Feb. 5, 2015

(54) IMAGE FIXING DEVICE AND IMAGE FORMING APPARATUS HAVING THE SAME

(71) Applicant: Samsung Electronics Co., Ltd., Suwon-si (KR)

(72) Inventors: Jeong Chul SONG, Gwangmyeong-si (KR); Sun Hyung LEE, Yangyang-gun (KR); Jin Yoon KIM, Suwon-si (KR); Su Ho SHIN, Seoul (KR)

(73) Assignee: SAMSUNG ELECTRONICS. CO., LTD.

(21) Appl. No.: 14/341,085

(22) Filed: Jul. 25, 2014

(30) Foreign Application Priority Data
Aug. 2, 2013 (KR) 10-2013-0092201

(51) Int. Cl. G03G 15/20

(52) U.S. Cl. CPC G03G 15/2053; G03G 2215/2041
USPC 399/329

(57) ABSTRACT

Disclosed herein are an image fixing device and an image forming apparatus having the same. The image fixing device includes a fixing belt which is rotatably disposed, and a pressure roller which is disposed to be opposite to the fixing belt and thus to press an outer circumferential surface of the fixing belt, wherein the fixing belt includes a fixing part of which an outer surface has a first friction coefficient, and a meandering movement preventing part which is located at each of both ends of the fixing part in a length direction of the fixing belt, and of which an outer surface has a second friction coefficient greater than the first friction coefficient. By the configuration, a meandering movement of the fixing belt is prevented, and thus it is possible to improve fixing efficiency.

### CROSS-REFERENCE TO RELATED APPLICATIONS

This application claims the priority benefit of Korean Patent Application No. 10-2013-0092201, filed on Aug. 2, 2013 in the Korean Intellectual Property Office, the disclosure of which is incorporated herein by reference.

### BACKGROUND

1. Field

Embodiments relate to an image fixing device and an image forming apparatus having the same.

2. Description of the Related Art

In general, an image forming apparatus is to print an image on a printing medium, and as the image forming apparatus, there are, for example, a printer, a copy machine, a fax machine, an all-in-one printer in which functions thereof are incorporated, and so forth.

In an electro-photographic type image forming apparatus, light is scanned on a photoreceptor charged with a predetermined potential so as to form an electrostatic latent image on a surface of the photoreceptor, and a toner is supplied to the electrostatic latent image so as to form a visible image. The visible image formed on the photoreceptor may be directly transferred on the printing medium, or may be transferred on the printing medium through an intermediate transfer, and then may be fixed on the printing medium while passing through an image fixing device.

In general, the image fixing device includes a fixing belt including a roller, a belt, or the like, and a pressure roller which is in close contact with the fixing belt and forms a fixing nib. If a printing medium on which a toner image is transferred enters between the fixing belt and the pressure roller, the toner image is fixed on the printing medium by heat transferred from a heating member and pressure applied from the fixing nib. An internal member is provided in the fixing belt so as to support an inside of the fixing belt and thus to form a nib between the pressure roller and the internal member.

In this process, the fixing belt should be rotated only in an axial direction and thus should form the pressure roller and the fixing nib. However, if a rotational axis of the fixing belt is not parallel with a rotational axis of the pressure roller, a frictional force distribution on each of inner and outer surfaces of the fixing belt is different from each other, and thus the fixing belt has a meandering movement in the axial direction.

If the fixing belt has the meandering movement, both ends of the fixing belt are in contact with a supporting member supporting a rotation of the fixing belt, and thus the fixing belt may be worn or damaged.

### SUMMARY

In an aspect of one or more embodiments, there is provided an image fixing device which prevents a fixing belt from being moved meanderingly or returns the fixing belt to its original position, and an image forming apparatus having the same.

In an aspect of one or more embodiments, there is provided an image fixing device includes a fixing belt which is rotatably disposed, and a pressure roller which is disposed to be opposite to the fixing belt and thus to press an outer circumferential surface of the fixing belt, wherein the fixing belt includes a fixing part of which an outer surface has a first friction coefficient μo1, and a meandering movement preventing part which is located at each of both ends of the fixing part in a length direction of the fixing belt, and of which an outer surface has a second friction coefficient μo2 greater than the first friction coefficient μo1.

The meandering movement preventing part may include a first meandering movement preventing part disposed at one side of the fixing belt, and a second meandering movement preventing part disposed at the other side of the fixing belt, and when the fixing belt is biased to the one side, a surface area on which the first meandering movement preventing part is in contact with the pressure roller may be reduced.

The meandering movement preventing part may include a first meandering movement preventing part disposed at one side of the fixing belt, and a second meandering movement preventing part disposed at the other side of the fixing belt, and when the fixing belt is biased to the one side, a surface area on which the second meandering movement preventing part is in contact with the pressure roller may be increased.

When the fixing belt is biased to the one side, a frictional force generated at the second meandering movement preventing part may be greater than that generated at the first meandering movement preventing part.

The meandering movement preventing part may be provided to have a higher roughness than that of the fixing part.

The fixing belt may include a supporting body, an elastic layer provided on an outer circumferential surface of the supporting body, and a release layer provided on an outer circumferential surface of the elastic layer and having the fixing part formed therein, and the meandering movement preventing part may be provided so that at least a part of the release layer is removed and the elastic layer is exposed to an outside.

The meandering movement preventing part may be formed by coating both ends of the fixing belt with a high frictional material having the second friction coefficient.

The meandering movement preventing part formed of the high frictional material may have a larger diameter than that of the fixing part.

The fixing belt may include a passing part through which a printing medium passes between the fixing belt and the pressure roller, and a non-passing part through which the printing medium does not pass, and the meandering movement preventing part may be formed at the non-passing part.

The image fixing device may further include a belt guide which includes a belt restricting surface restricting a length directional movement of the fixing belt and is disposed at each of length directional both ends of the fixing belt.

The belt restricting surface may include a first belt restricting surface disposed at one side of the fixing belt, and a second belt restricting surface disposed at the other side of the fixing belt, and the pressure roller may include a pressure elastic layer provided to be in contact with the fixing belt, and a distance LF between the first belt restricting surface and the second belt restricting surface and a length LP from one end of the pressure elastic layer to the other end thereof may satisfy the following relationship: LP<LF.

The distance LF between the first belt restricting surface and the second belt restricting surface, a length LB from one end of the fixing belt to the other end thereof, and a length LR of a space allowing the fixing belt to be movable in a length direction may satisfy the following relationship: LF=LB+LR.

A length LBC between one end of the fixing part and the other end thereof, a length LBE between one end of the meandering movement preventing part and the other end thereof, and a distance LS between one end of the pressure elastic layer and the first belt restricting surface may satisfy the following relationship: LBC+LBE<LP+LS.

The length LBC between the one end of the fixing part and the other end thereof may satisfy the following relationship: LBC<LP.

The length LBC between the one end of the fixing part and the other end thereof and the length LBE between the one end of the meandering movement preventing part and the other end thereof may satisfy the following relationship: LP<LBC+2*LBE.

The length LBE between the one end of the meandering movement preventing part and the other end thereof and the distance LS between the one end of the pressure elastic layer and the first belt restricting surface may satisfy the following relationship: LBE<LS.

The length LBC between the one end of the fixing part and the other end thereof, the length LBE between the one end of the meandering movement preventing part and the other end thereof, and the distance LS between the one end of the pressure elastic layer and the first belt restricting surface may satisfy the following relationship: 2*LBE+LBC<LP+LS.

The fixing belt may further include a surface to be pressed, which is provided at an inner surface of the fixing part so as to have a third friction coefficient, and an internal meandering movement preventing surface which is disposed at each of both ends of a part to be pressed, in the length direction of the fixing belt, and formed at an inner circumferential surface of the fixing belt so as to have a fourth friction coefficient less than the third friction coefficient.

In an aspect of one or more embodiments, there is provided an image fixing device which includes a fixing belt which is in contact with a printing medium having a non-fixed image so as to transfer heat and provided to be rotatable, and a pressure roller disposed to be in pressure contact with an outer circumferential surface of the fixing belt, wherein the pressure roller includes a pressure elastic part provided to press the fixing belt, and a meandering movement preventing part located at both ends of the pressure elastic part in a length direction of the pressure roller and formed on an outer circumferential surface of the pressure roller to have a different friction coefficient from that of the pressure elastic part.

The pressure elastic part may have a first friction coefficient μp1, and the meandering movement preventing part may have a second friction coefficient μp2 which is less than the first friction coefficient μp1.

The meandering movement preventing part may include a first meandering movement preventing part disposed at one side of the pressure roller, and a second meandering movement preventing part disposed at the other side of the pressure roller, and when the fixing belt is biased to the one side, a surface area on which the first meandering movement preventing part is in contact with the fixing belt may be increased.

The meandering movement preventing part may include a first meandering movement preventing part disposed at one side of the pressure roller, and a second meandering movement preventing part disposed at the other side of the pressure roller, and when the fixing belt is biased to the one side, a surface area on which the second meandering movement preventing part is in contact with the fixing belt may be reduced.

The fixing belt may include a first fixing belt at the one side based on a center of the length direction and a second fixing belt at the other side thereof, and when the fixing belt is biased to the one side, a frictional force generated by the first fixing belt and the pressure roller may be less than that generated by the second fixing belt and the pressure roller.

The pressure elastic part may be coated with a material having the first friction coefficient μp1.

The meandering movement preventing part may be coated with a material having the second friction coefficient μp2. According an aspect of one or more embodiments, an image fixing device includes a pressure roller provided to be rotatable, a fixing belt disposed on an outer circumferential surface of the pressure roller to be in contact with the pressure roller, and a pressure member disposed in the fixing belt to press the fixing belt toward the pressure roller, wherein the fixing belt includes a fixing part having a surface to be pressed, which is provided on an inner surface thereof to be pressed by the pressure member, and a meandering movement preventing part having a meandering movement preventing surface provided on an inner surface thereof and located at both ends of the fixing part in a length direction of the fixing belt.

The fixing part may further include a fixing surface provided on an outer surface thereof, and the fixing surface may be in contact with the pressure roller, and the surface to be pressed and the meandering movement preventing surface may be in contact with the pressure member.

A friction coefficient μo of the fixing surface, a friction coefficient μi1 of the surface to be pressed, and a friction coefficient μi2 of the meandering movement preventing surface may satisfy the following relationship: μo>μi1>μi2.

The surface to be pressed may have a first friction coefficient μi1, and the meandering movement preventing surface may have a second friction coefficient μi2 which is less than the first friction coefficient μi1.

The meandering movement preventing surface may be formed by coating the both ends of the inner circumferential surface of the fixing belt with a low frictional material having the second friction coefficient μi2.

The meandering movement preventing part may include a first meandering movement preventing part disposed at one side of the fixing belt, and a second meandering movement preventing part disposed at the other side of the fixing belt, and, when the fixing belt is biased to the one side, a surface area on which the first meandering movement preventing part is in contact with the pressure roller may be reduced.

The meandering movement preventing part may include a first meandering movement preventing part disposed at one side of the fixing belt, and a second meandering movement preventing part disposed at the other side of the fixing belt, and, when the fixing belt is biased to the one side, a surface area on which the second meandering movement preventing part is in contact with the pressure roller may be increased.

In an aspect of one or more embodiments, there is provided an image forming apparatus which includes an image fixing device configured to apply heat and pressure and thus to fix a non-fixed image on a printing medium includes a fixing belt having a fixing part through which the printing medium passes, in contact with a surface of the printing medium having a non-fixed image so as to transfer heat, and provided to be rotatable, a belt guide disposed at length directional both ends of the fixing belt so that the fixing belt is rotatably supported, a pressure roller having a pressure elastic part for pressing the fixing belt and disposed to be opposite to the fixing belt, and a meandering movement preventing part having a different friction coefficient from one of the fixing part and the pressure elastic part and disposed at the length directional both ends.

In an aspect of one or more embodiments, there is provided an image forming apparatus which includes a fixing belt configured to be rotatable, wherein the fixing belt includes a fixing part which has an outer surface having a first friction coefficient, and a meandering movement preventing part which is located at each of both ends of the fixing part in a length direction of the fixing belt, and which has an outer surface having a second friction coefficient which is greater than the first friction coefficient.

### BRIEF DESCRIPTION OF THE DRAWINGS

These and/or other aspects of the invention will become apparent and more readily appreciated from the following description of embodiments, taken in conjunction with the accompanying drawings of which:

FIG. 1 is a cross-sectional view of an image forming apparatus according to an embodiment;

FIG. 2 is a perspective view of an image fixing device according to an embodiment;

FIG. 3 is a cross-sectional view of the image fixing device according to an embodiment;

FIG. 4 is a front view of the image fixing device according to an embodiment;

FIG. 5 is a view illustrating generation of meandering force according to an embodiment;

FIG. 6A is a view illustrating an operation of the image fixing device according to an embodiment;

FIG. 6B is a view illustrating a frictional force distribution of the image fixing device according to an embodiment;

FIG. 7A is a view illustrating the operation of the image fixing device according to an embodiment;

FIG. 7B is a view illustrating the frictional force distribution of the image fixing device according to an embodiment;

FIG. 8 is a view illustrating an improvement of the meandering force in the image fixing device according to an embodiment;

FIG. 9 is a view illustrating a fixing belt according to an embodiment;

FIG. 10 is a view illustrating a fixing belt according to an embodiment;

FIG. 11 is a front view of an image fixing device according to an embodiment;

FIG. 12 is a front view of an image fixing device according to an embodiment;

FIG. 13A is a view illustrating an operation of the image fixing device according to an embodiment;

FIG. 13B is a view illustrating a frictional force distribution of the image fixing device according to an embodiment;

FIG. 14A is a view illustrating the operation of the image fixing device according to an embodiment;

FIG. 14B is a view illustrating the frictional force distribution of the image fixing device according to an embodiment; and

FIG. 15 is a front view of an image fixing device according to an embodiment.

### DETAILED DESCRIPTION

Reference will now be made in detail to embodiments, examples of which are illustrated in the accompanying drawings, wherein like reference numerals refer to like elements throughout.

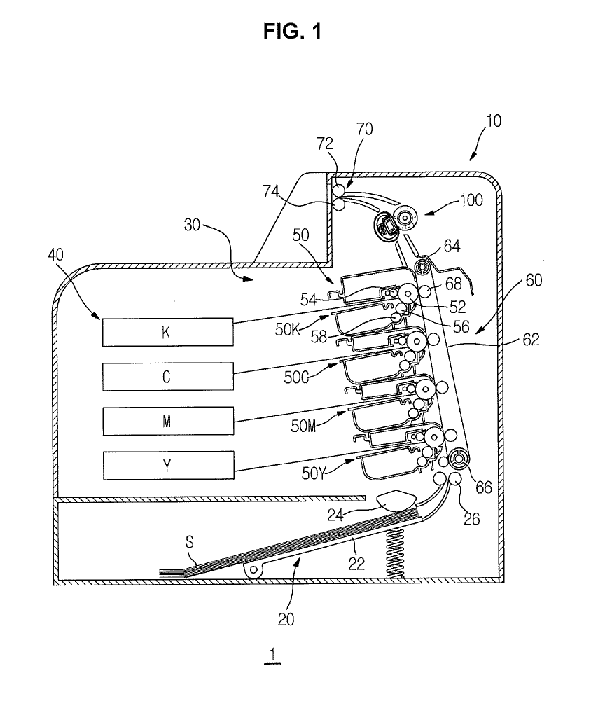

FIG. 1 is a cross-sectional view of an image forming apparatus according to an embodiment.

As illustrated in FIG. 1, an image forming apparatus 1 includes a main body 10, a printing medium supplying device 20, a printing device 30, an image fixing device 100, and a printing medium discharging device 70.

The main body 10 serves to form an external appearance of the image forming apparatus and also to support various components installed therein. The main body 10 includes a cover (not shown) which is provided to open and close a part of the main body 10, and a main body frame (not shown) which supports or fixes the various components in the main body 10.

The printing medium supplying device 20 serves to supply a printing medium S to the printing device 30. The printing medium supplying device 20 includes a tray 22 in which the printing medium S is loaded, and a pick-up roller 24 which picks up the printing medium, one sheet at a time, which is loaded in the tray 22. The printing medium picked up by the pick-up roller 24 is transported to the printing device 30 by a transport roller 26.

The printing device 30 may include a light scanning device 40, a developing device 50, and a transferring device 60.

The light scanning device 40 includes an optical system (not shown) and serves to scan light corresponding to image information of a yellow color Y, a magenta color M, a cyan color C, and a black color K to the developing device 50 according to a printing signal.

The developing device 50 forms a toner image according to the image information input from an external apparatus such as a computer. In an embodiment, the image forming apparatus 1 is a color image forming apparatus, and the developing device 50 includes 4 developers 50Y, 50M, 50C, and 50K in which each toner of the yellow color Y, the magenta color M, the cyan color C, and the black color K is received.

Each of the developers 50Y, 50M, 50C, and 50K may include a photoreceptor 52 having an electrostatic latent image formed on a surface thereof by the light scanning device 40, a charge roller 54 charging the photoreceptor 52, a developing roller 56 providing the toner image on the electrostatic latent image formed on the photoreceptor 52, and a supplying roller 58 supplying the toner to the developing roller 56.

The transferring device 60 serves to transfer the toner image formed on the photoreceptor 52 to the printing medium. The transferring device 60 may include a transfer belt 62 which is in contact with each photoreceptor 52 and performs a track circulation, a driving roller 64 which drives the transfer belt 62, a tension roller 66 which maintains a tension of the transfer belt 62, and four transfer rollers 68 which transfer the toner image developed on the photoreceptor 52 to the printing medium.

The printing medium is attached to the transfer belt 62 and thus transported at the same speed as that of the transfer belt 62. At this time, a voltage having an opposite polarity to that of the toner attached to each photoreceptor 52 is applied to each of the transfer rollers 68, and thus the toner image on the photoreceptor 52 is transferred to the printing medium.

The image fixing device 100 serves to fix the toner image transferred to the printing medium by the transferring device 60 to the printed medium. Description of the image fixing device 100 will be described later.

The printing medium discharging device 70 serves to discharge the printing medium to an outside of the main body 10. The printing medium discharging device 70 includes a discharging roller 72 and a pinch roller 74 disposed to be opposite to the discharging roller 72.

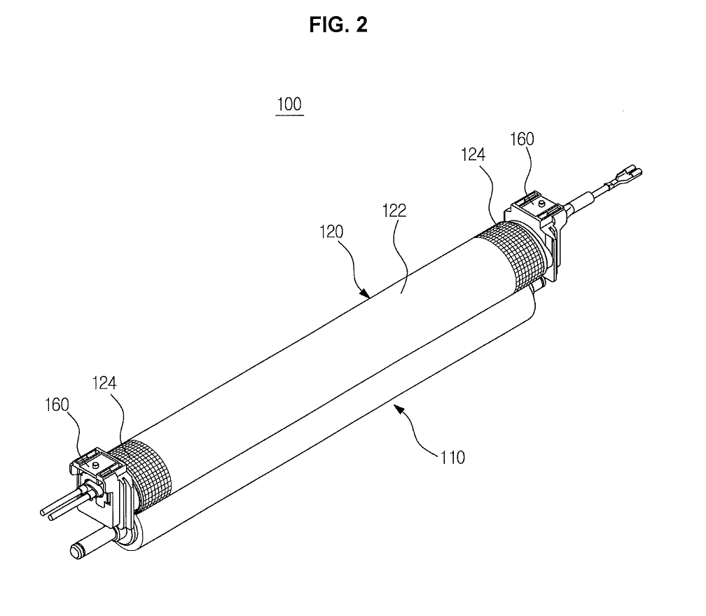

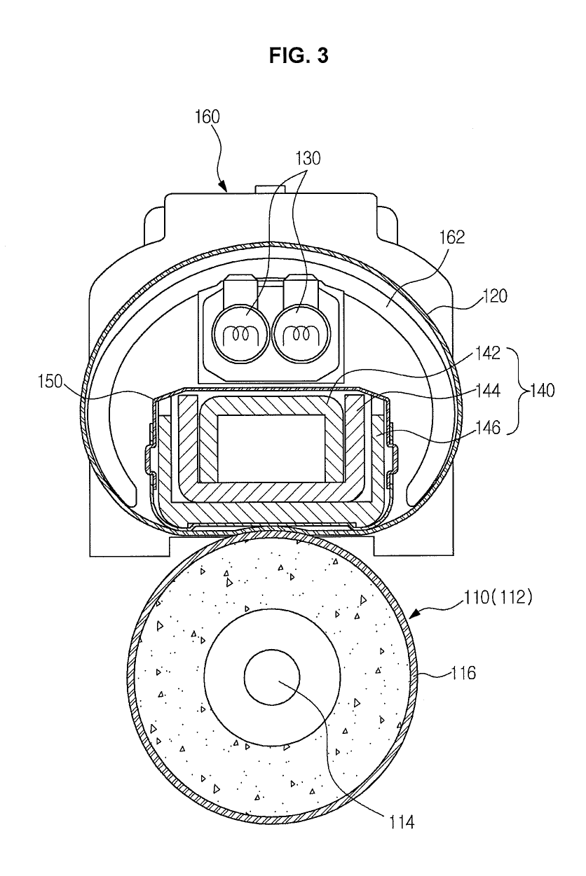

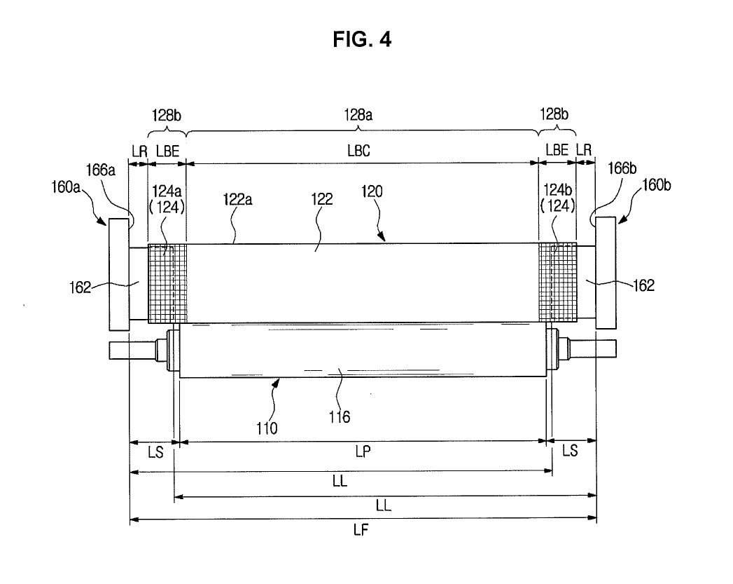

FIG. 2 is a perspective view of the image fixing device according to an embodiment, FIG. 3 is a cross-sectional view of the image fixing device according to an embodiment, and FIG. 4 is a front view of the image fixing device according to an embodiment.

Hereinafter, it is defined that a width direction of the printing medium S, a width direction of a pressure roller 110, and a width direction of a pressure member 140 mean the same direction (X).

As illustrated in FIGS. 2 to 4, the image fixing device 100 includes the pressure roller 110, a fixing belt 120, a heat source 130, the pressure member 140, and a heat blocking member 150.

The printing medium S to which the toner image is transferred passes through between the pressure roller 110 and the fixing belt 120. At this time, the toner image is fixed to the printing medium by heat and pressure.

The pressure roller 110 is disposed to be in contact with an outer circumferential surface of the fixing belt 120 and forms a fixing nib N between the fixing belt 120 and the pressure roller 110. The pressure roller 110 may include a pressure elastic layer which is provided at an outer circumferential surface thereof to be in contact with the fixing belt 120. The pressure roller 110 may be configured with a fixing roller 112 which receives driving power from a driving source (not shown) so as to be rotated.

The pressure roller 110 includes a shaft 114 formed of a metallic material such as aluminum and steel, and a pressure elastic layer 116 which is elastically deformed and forms the fixing nib N between the fixing belt 120 and the pressure elastic layer 116. The pressure elastic layer 116 is typically formed of silicon rubber. The pressure elastic layer 116 may have a hardness of 50 or more and 80 or less in ASKER-C hardness and a thickness of 3 mm or more and 6 mm or less, such that a high fixing pressure in the fixing nib N is applied to the printing medium S. A release layer (not shown) preventing the printing medium from being adhered to the fixing roller 112 may be provided on a surface of the pressure elastic layer 116.

The fixing belt 120 is rotated in a state of being engaged with the pressure roller 110, forms the fixing nib N together with the pressure roller 110, is heated by the heat source 130, and transfers heat to the printing medium S passing through the fixing nib N. The fixing belt 120 may be formed into a single layer formed of a metal or a heat resistant polymer, or a basic layer formed of the metal or the heat resistant polymer, to which an elastic layer and a protective layer are added. An inner surface of the fixing belt 120 may be colored or coated with a black color in order to promote heat absorption.

The heat source 130 is disposed so as to directly radiant-heat at least a part of an inner circumferential surface of the fixing belt 120. At least two or more heat sources 130 may be provided to enhance an image fixing performance. A halogen lamp may be used for the heat source 130, and an electric heating wire, a planer heating element, or the like other than the halogen lamp may also be used.

Belt guides 160 are disposed at both sides of the fixing belt 120. The belt guides 160 serve to support construction components of the image fixing device 100. The fixing belt 120 may be rotatably supported by the belt guides 160. Each of the belt guides 160 includes a belt rotation guide 162 which protrudes toward the fixing belt 120 so as to support an end of the fixing belt 120.

The belt guides 160 are respectively pressed toward the pressure roller 110 by an elastic member (not shown). One end of the elastic member (not shown) is supported to an upper portion of the belt guide 160, and the other end thereof is supported to a separate frame.

The pressure member 140 applies a pressure to the inner circumferential surface of the fixing belt 120 so as to form the fixing nib N between the fixing belt 120 and the pressure roller 110. The pressure member 140 may be formed of a material having an excellent strength, such as stainless and carbon steel.

If the pressure member 140 has a low strength, an excessive bending deformation may occur in the pressure member 140, and thus the pressure member 140 may not uniformly press the fixing nib N. Therefore, in order to reduce the bending deformation, the pressure member 140 includes a first pressure member 142 having an arch-shaped cross-section and a second pressure member 144 having a reversed arch-shaped cross-section. The first and second pressure members 142 and 144 are coupled with each other so that at least a part of the first pressure member 142 is received in the second pressure member 144. The pressure member 140 may be formed into a structure having a large cross-sectional inertia moment, such as an I-beam type, an H-beam type, and the like other than the arch shape and the reversed arch shape.

If the radiant heat of the heat source 130 directly heats the pressure member 140, the pressure member 140 is heated to a high temperature and thermally deformed, and thus the pressure member 140 may not uniformly press the fixing nib N. Further, if most of the heat radiated from the heat source 130 is used for heating the pressure member 140, a heating performance of the image fixing device 100 is deteriorated.

Therefore, the image fixing device 100 includes the heat blocking member 150 disposed between the heat source 130 and the pressure member 140. The heat blocking member 150 is disposed to enclose at least a part of the pressure member 140, particularly an upper portion of the pressure member 140 opposite to the heat source 130 so as to block the heat directly radiated to the pressure member 140, thereby preventing the pressure member 140 from being thermally deformed.

The heat blocking member 150 may include a reflecting layer (not shown) reflecting the heat of the heat source 130. The reflecting layer (not shown) may be provided on a surface of the heat blocking member 150 opposite to the heat source 130. The reflecting layer (not shown) may be formed by coating the heat blocking member 150 with a reflecting material such as silver. As described above, if the reflecting layer (not shown) is formed at the heat blocking member 150. The heat radiated to the heat blocking member 150 is reflected to the fixing belt 120, and thus promotes the heating of the fixing belt 120.

The heat blocking member 150 is formed of a material having a good thermal conductivity. The heat blocking member 150 may be formed of a material having a higher thermal conductivity than that of the pressure member 140. For example, the heat blocking member 150 may be formed of aluminum, copper, or an alloy thereof.

The pressure member 140 may further include a pressure supporting member 180. The pressure supporting member 180 is disposed between the pressure member 140 and the fixing belt 120 so as to effectively transmit a pressure generated from the pressure member 140 to the fixing belt and also to reduce frictional force between the pressure member 140 and the fixing belt 120.

The image fixing device 100 may include a meandering movement preventing part. The meandering movement preventing part will be described below in detail.

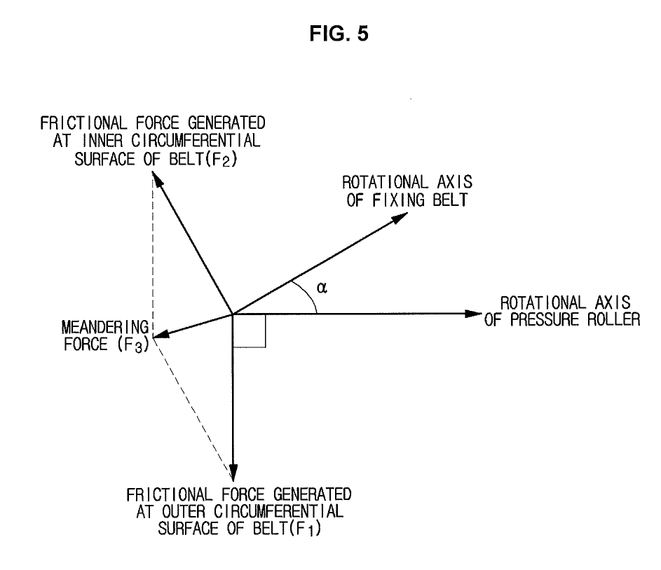

FIG. 5 is a view illustrating generation of meandering force according to an embodiment.

A rotational shaft of the fixing belt 120 and a rotation shaft of the pressure roller 110 should be parallel with each other. However, a fine error may occur due to design reasons or the like. If the rotational shaft of the fixing belt 120 and the rotation shaft of the pressure roller 110 are not parallel with each other, the fixing belt 120 has a different thickness over an entire length, a pressure deviation occurs, or the like, the fixing belt 120 may be moved in a length direction, instead of a rotational axial direction.

Specifically, a direction of a frictional force F1 between the outer circumferential surface of the fixing belt and the outer circumferential surface of the pressure roller should be opposite to that of a frictional force F2 between the inner circumferential surface of the fixing belt and the pressure member. If the rotational shaft of the fixing belt 120 and the rotation shaft of the pressure roller 110 are not parallel with each other, a force component in the length direction of the fixing belt 120 is generated, and thus a meandering force F3 is generated.

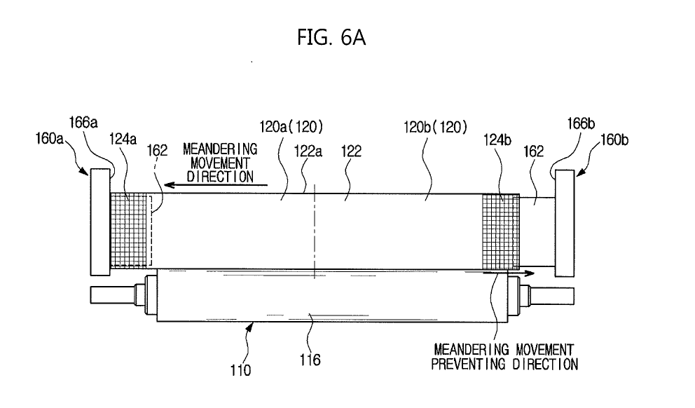

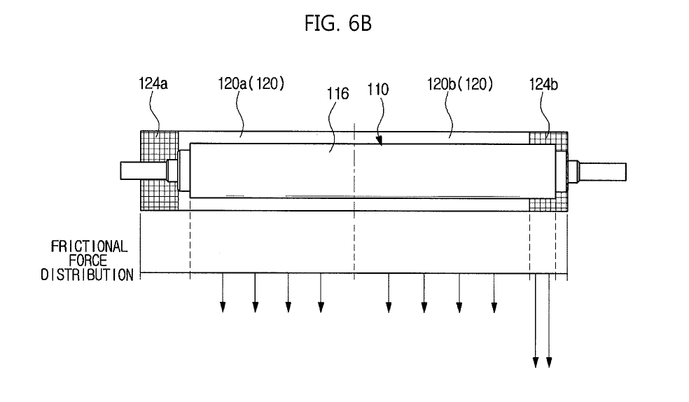

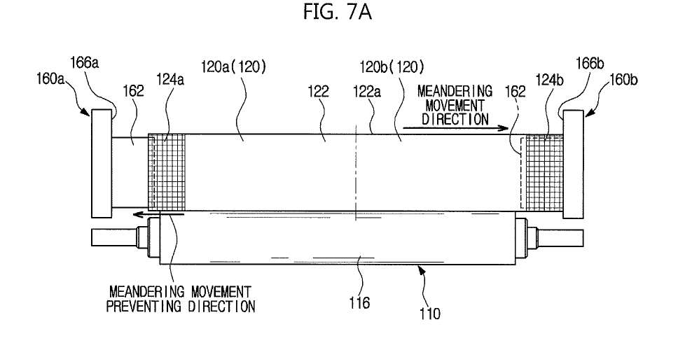

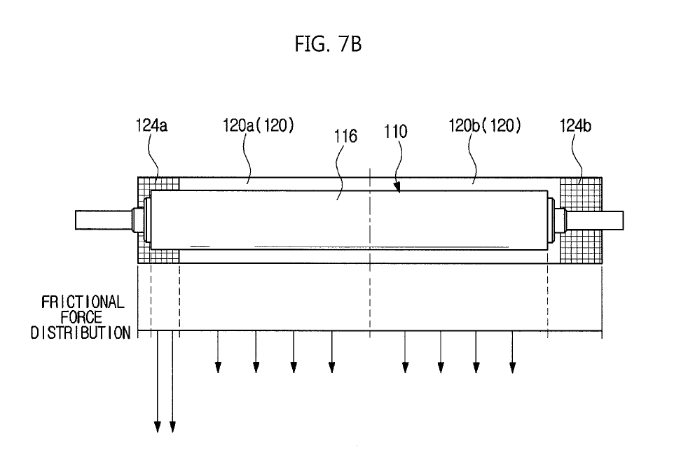

FIG. 6A is a view illustrating an operation of the image fixing device according to an embodiment as shown in FIG. 1, FIG. 6B is a view illustrating a frictional force distribution of the image fixing device according to an embodiment as shown in FIG. 1, FIG. 7A is a view illustrating the operation of the image fixing device according to an embodiment as shown in FIG. 1, and FIG. 7B is a view illustrating the frictional force distribution of the image fixing device according to an embodiment as shown in FIG. 1.

As illustrated in FIGS. 2 to 7B, in one or more embodiments, the fixing belt 120 may include a fixing part 122 and a meandering movement preventing part 124.

The fixing part 122 is in contact with the pressure roller 110 and forms the fixing nib N, and a fixing surface 122a having a first friction coefficient μo1 may be formed on an outer surface of the fixing part 122.

The meandering movement preventing part 124 is formed at both ends of the fixing part 122 in the length direction of the fixing belt 120, and a meandering movement preventing surface 125 having a second friction coefficient μo2 may be formed on an outer surface of the meandering movement preventing part 124. The second friction coefficient μo2 may be higher than the first friction coefficient μo1.

In a different view, the fixing belt 120 may include a passing part 128a through which the printing medium passes between the fixing belt 120 and the pressure roller 110, and a non-passing part 128b through which the printing medium does not pass. The meandering movement preventing part 124 may be formed at the non-passing part 128b.

The meandering movement preventing part 124 is disposed at both ends of the fixing part 122, and allows that, when the fixing belt 120 is moved in the length direction, a frictional force distribution between the pressure roller 110 and the fixing belt 120 is changed and thus the fixing belt 120 is returned to its original position.

Specifically, the meandering movement preventing part 124 may include a first meandering movement preventing part 124a disposed at one side of the fixing belt 120, and a second meandering movement preventing part 124b disposed at the other side of the fixing belt 120. The meandering movement preventing part 124 may be configured that, when the fixing belt 120 is biased to the one side, a surface area on which the first meandering movement preventing part 124a is in contact with the pressure roller 110 is reduced, and a surface area on which the second meandering movement preventing part 124b is in contact with the pressure roller 110 is increased.

For convenience of explanation, one side of the fixing belt 120 based on a center of the length direction will be referred to as a first fixing belt 120a, and the other side will be referred to as a second fixing belt 120b. When the fixing belt 120 has a meandering movement to the one side, the surface area on which the first meandering movement preventing part 124a is in contact with the pressure roller 110 is reduced, and the surface area on which the second meandering movement preventing part 124b is in contact with the pressure roller 110 is increased. At this time, since the frictional force at the second fixing belt 120b having the second meandering movement preventing part 124b is greater than that at the first fixing belt 120a having the first meandering movement preventing part 124a, the fixing belt 120 may be moved to the other side. If the second friction coefficient μo2 at the meandering movement preventing part 124 is sufficiently greater than the first friction coefficient μo1 at the fixing part 122, the meandering force causing the meandering movement may be offset, and thus the fixing belt 120 may be moved again to the other side, or the meandering force causing the meandering movement may be reduced.

The meandering movement preventing part 124 may be formed in various manners. For example, the meandering movement preventing part 124 may be provided to have a higher roughness than that of the fixing part 122. That is, the meandering movement preventing part 124 may be formed to have the higher surface roughness than that of the fixing part 122 and thus to have a higher friction coefficient.

In another manner, the meandering movement preventing part 124 may have the higher friction coefficient by removing an external configuration of the fixing part 122. Specifically, the fixing belt 120 may include a supporting body, an elastic layer provided on an outer circumferential surface of the supporting body, and a release layer provided on an outer circumferential surface of the elastic layer. The fixing part 122 may include the supporting body, the elastic layer, and the release layer, and the meandering movement preventing part 124 may include the elastic layer which is exposed to an outside by removing the release layer.

In yet another manner, a high frictional material having the second friction coefficient μo2 higher than the first friction coefficient μo1 may be coated at the both ends of the fixing belt 120, such that the meandering movement preventing surface 125 of the meandering movement preventing part 124 has the second friction coefficient μo2 and thus generates the higher frictional force than the fixing part 122. In this case, the meandering movement preventing part 124 may have a greater diameter than that of the fixing part 122, and thus a higher pressure may be generated between the pressure roller 110 and the meandering movement preventing part 124, whereby it is possible to increase the frictional force.

As described above, the meandering movement preventing part 124 may be formed in various manners, and embodiments are not limited thereto. The meandering movement preventing part 124 may have other configurations which allow the meandering movement preventing part 124 to have the higher friction coefficient than that of the fixing part 122.

Since the inner circumferential surface of the fixing belt 120 which is in contact with the pressure member 140 should generate a lower frictional force than that at the outer circumferential surface thereof in order to enable the fixing belt 120 to be smoothly rotated, a friction coefficient μi of the inner circumferential surface of the fixing belt 120, the friction coefficient μo1 of the fixing part 122, and the friction coefficient μo2 of the meandering movement preventing part 124 may satisfy the following relationship:

μi<μo1<μo2.

Hereinafter, a length or distance relationship in each construction element of the image fixing device will be described.

The belt guide 160 may be provided at length directional both ends of the fixing belt 120. The belt guide 160 may include a belt restricting surface 166a, 166b which restricts a length directional movement of the fixing belt 120 and may be disposed at each of the length directional both ends of the fixing belt 120. Further, the belt guide 160 may include a belt rotation guide 162 which supports the both ends of the fixing belt 120 so that the fixing belt 120 may be rotatable.

The belt restricting surface 166a, 166b may be disposed to be opposed to each other. The belt restricting surface 166a, 166b may include a first belt restricting surface 166a disposed at one side of the fixing belt 120, and a second belt restricting surface 166b disposed at the other side of the fixing belt 120. Specifically, the belt guide 160 may include a first belt guide 160a disposed at the one side of the fixing belt 120 and a second belt guide 160b disposed at the other side of the fixing belt 120. And faced surfaces of the first belt guide 160a and the second belt guide 160b may be the first belt restricting surface 166a and the second belt restricting surface 166b.

In a relationship between the fixing belt 120 and the belt guide 160, when the belt restricting surface 166a, 166b is disposed to be in contact with the fixing belt 120, the both ends of the fixing belt 120 may be worn, or the fixing nib N may not be constantly formed. Therefore, it is necessary to provide a space allowing the meandering movement at a predetermined region of the fixing belt 120. A length LB between the one end of the fixing belt 120 and the other end thereof and a distance LF between the first and second belt restricting surfaces 166a and 166b may satisfy the following relationship:

LB<LF.

In other words, assuming that a length of the space allowing the meandering movement at a predetermined region of the fixing belt 120 is LR, it may satisfy the following relationship:

LF=LR+LB.

The fixing belt 120 needs the space allowing the meandering movement at a predetermined region of the fixing belt 120, but should not deviate from the belt rotation guide 162. Therefore, assuming that a distance from an end of the belt rotation guide 162 of one of the first and second belt guides 160a and 160b, which is at the side of the fixing belt 120, to the belt restricting surface 166a, 166b of the other one thereof is LL, it may satisfy the following relationship:

LL<LB.

A length LP between one end of the pressure elastic layer 116 of the pressure roller 110 and the other end thereof and the distance LF between the first and second belt restricting surfaces 166a and 166b which restrict the meandering movement of the fixing belt 120 have a relationship of LP<LF. In this relationship, assuming that a distance between the one end of the pressure elastic layer 116 of the pressure roller 110 and the first belt restricting surface 166a or a distance between the other end of the pressure elastic layer 116 and the second belt restricting surface 166b is LS, when the fixing belt 120 is biased to the one side by the meandering movement, a biased region of the fixing belt 120 corresponding to the distance LS is not in contact with the pressure roller 110.

Further, in the first meandering movement preventing part 124a located at one side of the fixing belt 120 and the second meandering movement preventing part 124b located at the other side thereof, when the fixing belt 120 is biased to the one side by the meandering movement, a surface area on which the first meandering movement preventing part 124a is in contact with the pressure elastic layer 116 is reduced, or a surface area on which the second meandering movement preventing part 124b is in contact with the pressure elastic layer 116 is increased. To this end, a length LBC between one end of the fixing part 122 and the other end thereof and a length LBE between one end of the meandering movement preventing part 124 and the other end thereof, which form the length LB of the fixing belt 120, have the following relationship with respect to the length LP between one end of the pressure elastic layer 116 and the other end thereof and the distance LS:

LBC+LBE<LP+LS.

In order for the frictional force to be reduced at a biased side of the fixing belt 120, it is necessary that the meandering movement preventing part 124 is in contact with the pressure elastic layer 116 before the fixing belt 120 is biased, and thus it may satisfy the following relationship:

LBC<LP.

Further, when the fixing belt 120 is biased to the one side, in order for the frictional force to be increased at an opposite side to the biased side, it is necessary that the surface area on which the second meandering movement preventing part 124b is in contact with the pressure elastic layer 116 is increased, and thus it should satisfy the following relationship:

LP<LBC+2×LBE,

and also in order for the frictional force generated between the second meandering movement preventing part 124b and the pressure elastic layer 116 to have a maximum value, it should satisfy the following relationship:

LBC+2×LBE<LP+LS.

When the fixing belt 120 is biased to the one side, in order for the frictional force generated between the first meandering movement preventing part 124a and the pressure elastic layer 116 to have a minimum value, i.e., in order for the first meandering movement preventing part 124a to be not in contact with the pressure elastic layer 116, it should satisfy the following relationship:

LBE<LS.

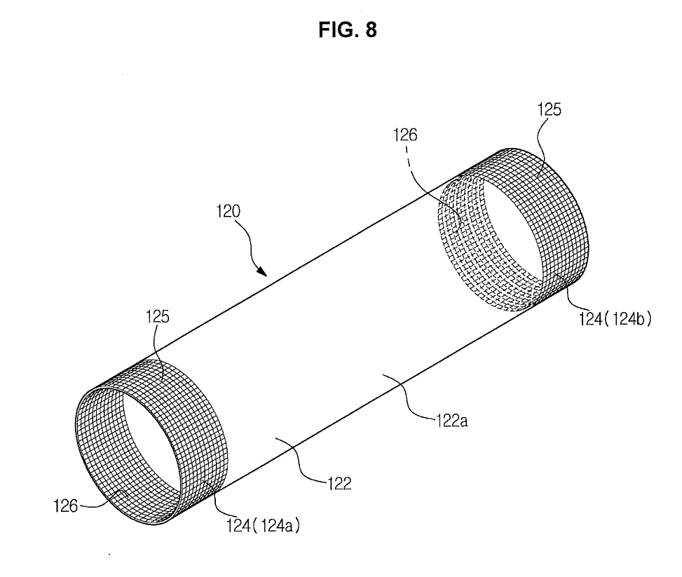

FIG. 8 is a graph illustrating a decrease in the meandering force through the configuration according to an embodiment.

If the first friction coefficient μo1 of the fixing part 122 is 0.3, and the second friction coefficient μo2 of the meandering movement preventing part 124 is 0.39, the meandering force generated in an existing image fixing device has an average value of 0.212 kgf, but the meandering force generated in the image fixing device according to an embodiment has an average value of 0.145 kgf, and thus it may be understood that about 31.4% of the meandering force generated in the existing image fixing device is reduced.

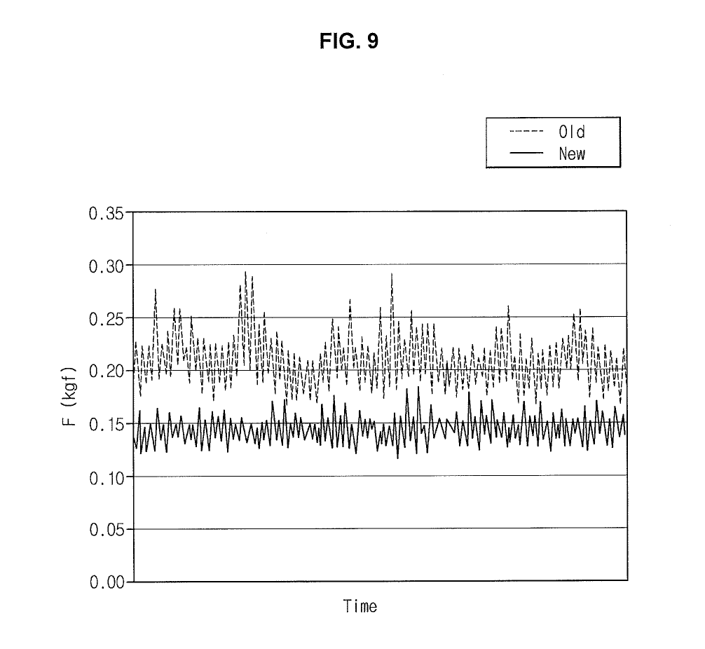

Hereinafter, an image fixing device and an image forming apparatus having the same according to an embodiment shown in FIG. 9 will be described. In an embodiment shown in FIG. 9, the description overlapping an embodiment shown in FIG. 1 is omitted.

FIG. 9 is a view illustrating a fixing belt according to an embodiment.

An image fixing device 100 of an embodiment may further include a surface 122b to be pressed, which is provided at an inner surface of the fixing part 122 in the fixing belt 120 of the first embodiment so as to have a third friction coefficient μi3, and an internal meandering movement preventing surface 126 which is disposed at each of both ends of a part to be pressed, in a length direction of the fixing belt 120, and formed at an inner circumferential surface of the fixing belt 120 so as to have a fourth friction coefficient μi4 less than the third friction coefficient μi3. The internal meandering movement preventing surface 126 may be provided at an inner surface of the meandering movement preventing part 124.

The surface 122b to be pressed and the internal meandering movement preventing surface 126 are in contact with the pressure member, and the frictional force distribution with the pressure member 140 may be different from each other.

The fixing belt 120 has an internal frictional force generated between the pressure member 140 and the fixing belt 120 and an external frictional force generated between the pressure roller 110 and the fixing belt 120. In an embodiment, the internal frictional force is reduced so that the external frictional force is relatively increased. A frictional force generated between the internal meandering movement preventing surface 126 of each of the first and second meandering movement preventing parts 124a and 124b and the pressure member 140 is the same. However, when the fixing belt 120 is biased to the one side, the surface area on which the first meandering movement preventing part 124a is in contact with the pressure roller 110 is reduced, but the surface area on which the second meandering movement preventing part 124b is in contact with the pressure roller 110 is increased. As a result, the frictional force generated between the second meandering movement preventing part 124b and the pressure roller 110 is increased.

Hereinafter, an image fixing device and an image forming apparatus having the same according to an embodiment will be described. In an embodiment, the description overlapping an embodiment in FIG. 1 will be omitted.

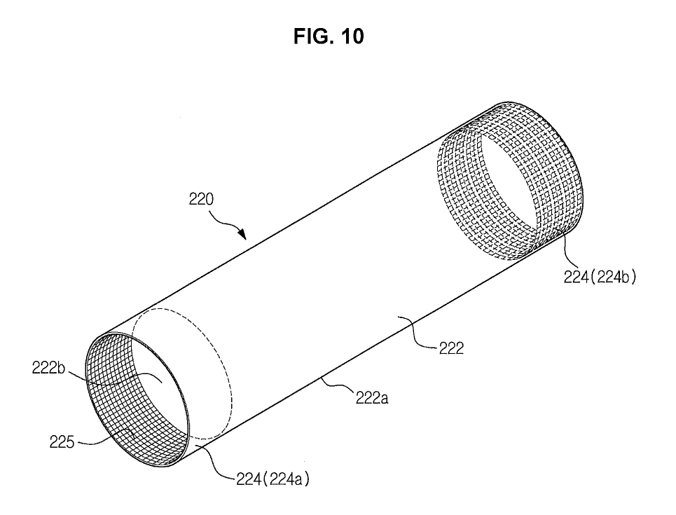

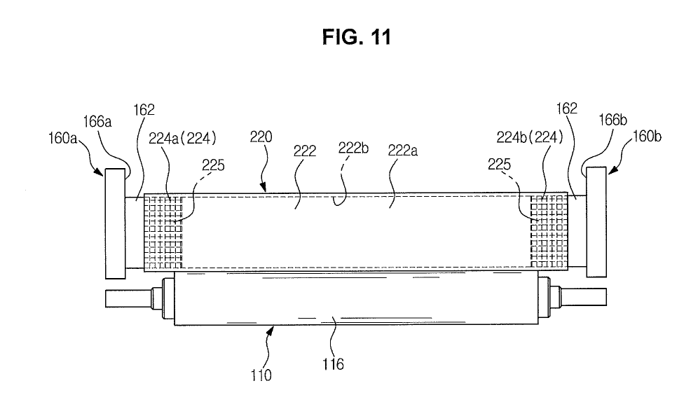

FIG. 10 is a view illustrating a fixing belt according to an embodiment, and FIG. 11 is a front view of the image fixing device according to an embodiment.

A fixing belt 220 of an image fixing device 200 may include a fixing part 222 and a meandering movement preventing part 224.

The fixing part 222 is a section of the fixing belt 220, which is in contact with a pressure roller 210. The fixing part 222 may include a fixing surface 222a which is provided on an outer surface thereof to be in contact with the pressure roller 210, and a surface 222b to be pressed, which is provided on an inner surface thereof to be pressed by the pressure member 140.

The meandering movement preventing part 224 is a configuration which is disposed at a length directional end of the fixing belt 220, and may be provided at both ends of the fixing part 222. The meandering movement preventing part 224 may include a meandering movement preventing surface 225 which is provided on an inner surface thereof to be pressed by the pressure member 140.

The fixing surface 222a may be in contact with the pressure roller 210, and the surface 222b to be pressed and the meandering movement preventing surface 225 may be in contact with the pressure member 140. The surface 222b to be pressed and the meandering movement preventing surface 225 may be directly in contact with the pressure member 140, as described above. However, when another element is disposed between the pressure member 140, and the surface 222b to be pressed and the meandering movement preventing surface 225, the surface 222b to be pressed and the meandering movement preventing surface 225 may be directly in contact with the other element.

The surface 222b to be pressed and the meandering movement preventing surface 225 are pressured by the pressure member 140 and may have a different friction coefficient from each other. The surface 222b to be pressed may have a first friction coefficient μi1, and the meandering movement preventing surface 225 may have a second friction coefficient μi2 lower than the first friction coefficient μi1. Since the fixing surface 222a has a higher friction coefficient than that of each of the surface 222b to be pressed and the meandering movement preventing surface 225 in order to enable the fixing belt 220 to be smoothly rotated, a friction coefficient μo of the fixing part 222 may satisfy the following relationship:

μo>μi1>μi2.

The meandering movement preventing surface 225 may be formed by coating both ends of an inner circumferential surface of the fixing belt 220 with a low frictional material so as to have the second friction coefficient μi2 lower than that of the surface 222b to be pressed. A method of forming the second friction coefficient μi2 which is lower than the first friction coefficient μi1 is not limited thereto, and other methods which enable the meandering movement preventing surface 225 to have the lower friction coefficient than that of the surface 222b to be pressed may be used.

The meandering movement preventing part 224 is disposed at both ends of the fixing part 222, and allows that, when the fixing belt 220 is moved in a length direction, a frictional force distribution between the pressure roller 210 and the fixing belt 220 is changed and thus the fixing belt 220 is returned to its original position.

Specifically, the meandering movement preventing part 224 may include a first meandering movement preventing part 224a disposed at one side of the fixing belt 220, and a second meandering movement preventing part 224b disposed at the other side of the fixing belt 220. The meandering movement preventing part 224 may be configured that, when the fixing belt 220 is biased to the one side, a surface area on which the first meandering movement preventing part 224a is in contact with the pressure roller 210 is reduced, and a surface area on which the second meandering movement preventing part 224b is in contact with the pressure roller 210 is increased.

The fixing belt 220 has an internal frictional force generated between the pressure member 140 and the fixing belt 220 and an external frictional force generated between the pressure roller 210 and the fixing belt 220. In an embodiment, the internal frictional force is reduced so that the external frictional force is relatively increased. A frictional force generated between the meandering movement preventing surface 225 of each of the first and second meandering movement preventing parts 224a and 224b and the pressure member 140 is the same. However, when the fixing belt 220 is biased to the one side, the surface area on which the first meandering movement preventing part 224a is in contact with the pressure roller 210 is reduced, but the surface area on which the second meandering movement preventing part 224b is in contact with the pressure roller 210 is increased. As a result, the frictional force generated between the second meandering movement preventing part 224b and the pressure roller 210 is increased.

For convenience of explanation, one side of the fixing belt 220 based on a center of the length direction will be referred to as a first fixing belt 220a, and the other side will be referred to as a second fixing belt 220b. When the fixing belt 220 has a meandering movement to the one side, the surface area on which the first meandering movement preventing part 224a is in contact with the pressure roller 210 is reduced, and the surface area on which the second meandering movement preventing part 224b is in contact with the pressure roller 210 is increased. At this time, since the frictional force at the second fixing belt 220b having the second meandering movement preventing part 224b is greater than that at the first fixing belt 220a having the first meandering movement preventing part 224a, the fixing belt 220 may be moved to the other side. If the second friction coefficient μi2 at the meandering movement preventing part 224 is sufficiently less than the first friction coefficient μi1 at the fixing part 222, the meandering force causing the meandering movement may be offset, and thus the fixing belt 220 may be moved again to the other side, or the meandering force causing the meandering movement may be reduced.

In the image fixing device according to an embodiment, since a length or distance relationship in each construction element is the same as that in the above-mentioned embodiment, description thereof will be omitted.

Hereinafter, an image fixing device and an image forming apparatus having the same according to an embodiment will be described. In an embodiment, the description overlapping an embodiment as shown in FIG. 1 will be omitted.

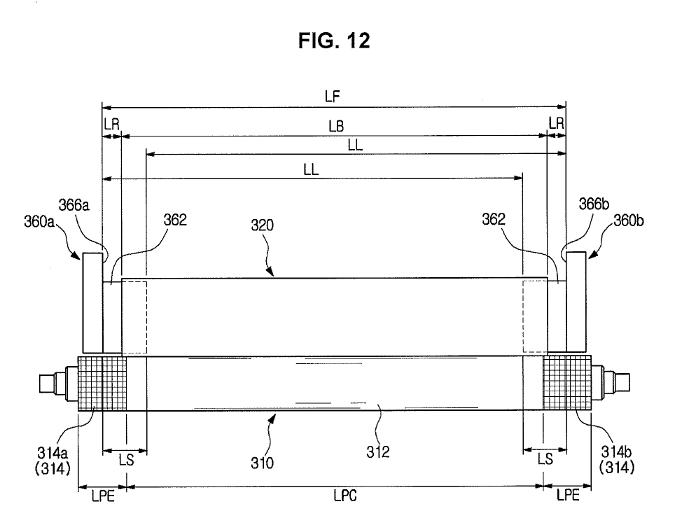

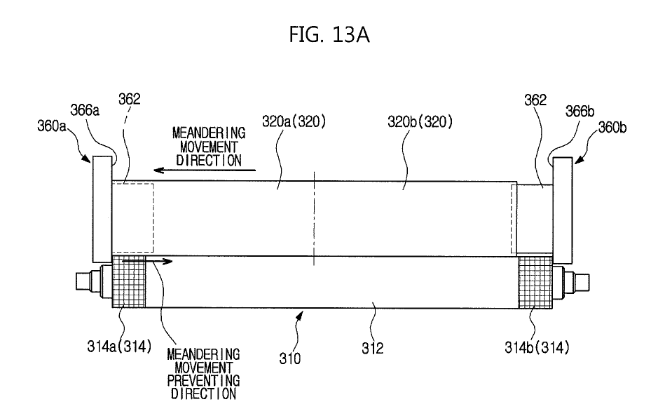

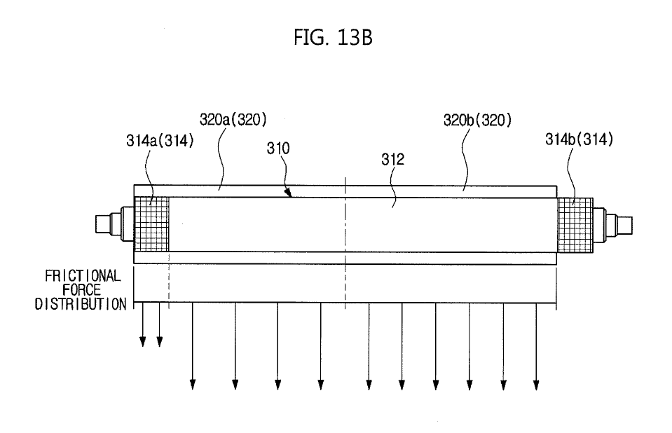

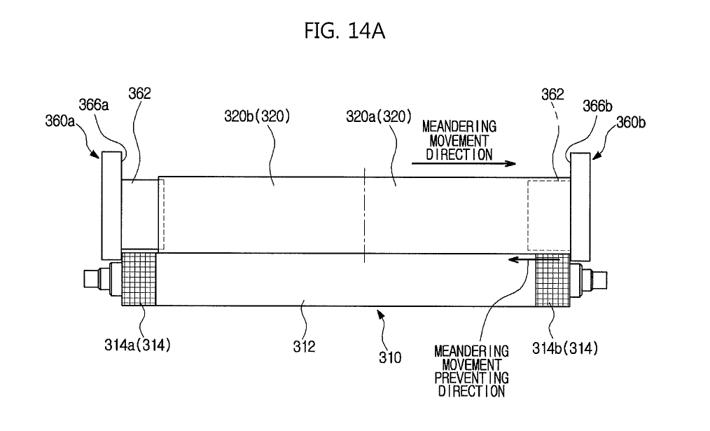

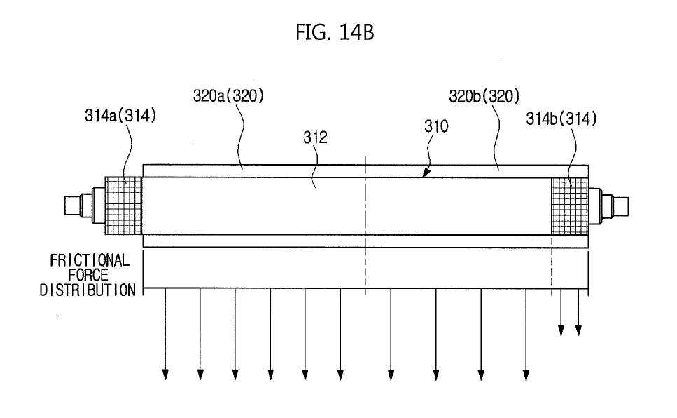

FIG. 12 is a front view of an image fixing device according to an embodiment, FIG. 13A is a view illustrating an operation of the image fixing device according to an embodiment, FIG. 13B is a view illustrating a frictional force distribution of the image fixing device according to an embodiment, FIG. 14A is a view illustrating the operation of the image fixing device according to an embodiment, and FIG. 14B is a view illustrating the frictional force distribution of the image fixing device according to an embodiment.

In the above-mentioned embodiments, a meandering movement preventing part 314 is provided at an outer or inner circumferential surface of a fixing belt 320. However, the meandering movement preventing part 314 is provided at a pressure roller 310.

In an embodiment, the pressure roller 310 of an image fixing device 300 may include a pressure elastic part 312 and the meandering movement preventing part 314.

The pressure elastic part 312 is a section in which an outer surface thereof presses the fixing belt 320, and may be formed at a passing part through which the printing medium passes.

The meandering movement preventing part 314 is disposed at both ends of the pressure elastic part 312 in a length direction of the pressure roller 310, and may be formed on an outer circumferential surface of the pressure roller 310 so as to have a difference friction coefficient from that of the pressure elastic part 312.

The pressure elastic part 312 may have a first friction coefficient μp1, and the meandering movement preventing part 314 may have a second friction coefficient μp2 which is less than the first friction coefficient μp1.

The meandering movement preventing part 314 is disposed at both ends of the pressure elastic part 312, and allows that, when the fixing belt 320 is moved in a length direction, a frictional force distribution between the pressure roller 310 and the fixing belt 320 is changed and thus the fixing belt 320 is returned to its original position.

Specifically, the meandering movement preventing part 314 may include a first meandering movement preventing part 314a disposed at one side of the pressure roller 310, and a second meandering movement preventing part 314b disposed at the other side of the pressure roller 310. The meandering movement preventing part 314 may be configured that, when the fixing belt 320 is biased to the one side, a surface area on which the first meandering movement preventing part 314a is in contact with the fixing belt 320 is increased, and a surface area on which the second meandering movement preventing part 314b is in contact with the pressure roller 310 is reduced.

For convenience of explanation, one side of the fixing belt 320 based on a center of the length direction will be referred to as a first fixing belt 320a, and the other side will be referred to as a second fixing belt 320b. When the fixing belt 320 has a meandering movement to the one side, the surface area on which the first meandering movement preventing part 314a is in contact with the fixing belt 320 is increased, and the surface area on which the second meandering movement preventing part 314b is in contact with the fixing belt 320 is reduced. Therefore, since the frictional force at the second fixing belt 320b having the second meandering movement preventing part 314b is greater than that at the first fixing belt 320a having the first meandering movement preventing part 314a, the fixing belt 320 may be moved to the other side. If the second friction coefficient μp2 at the meandering movement preventing part 314 is sufficiently less than the first friction coefficient μp1 at the pressure elastic part 312, the meandering force causing the meandering movement may be offset, and thus the fixing belt 320 may be moved again to the other side, or the meandering force causing the meandering movement may be reduced.

The pressure elastic part 312 and the meandering movement preventing part 314 of the pressure roller 310 may be coated with a different material from each other so as to have a different friction coefficient from each other. That is, the pressure elastic part 312 may be coated with a material having the first friction coefficient μp1, and the meandering movement preventing part 314 may be coated with a material having the second friction coefficient μp2 which is lower than the first friction coefficient μp1. An embodiment is not limited thereto and other methods which enable the meandering movement preventing part 314 to have a lower friction coefficient than that of the pressure elastic part 312 may be used.

Hereinafter, a length or distance relationship in each construction element of the image fixing device according to an embodiment will be described.

A distance between first and second belt restricting surfaces 366a and 366b is referred to as LF, a length between one end of the fixing belt 320 and the other end thereof is referred to as LB, a distance from the first belt restricting surface 366a of a first belt restricting guide 360a to an end of a belt rotation guide 362 of a second belt restricting guide 360b, or a distance from the second belt restricting surface 366b of the second belt restricting guide 360b to an end of the belt rotation guide 362 of the first belt restricting guide 360a is referred to as LL, a length between one end of the pressure elastic part 312 and the other end thereof in the pressure roller 310 is referred to as LPC, a length between one end of the meandering movement preventing part 314 and the other end thereof in the pressure roller 310 is referred to as LPE, and a distance from a boundary of the pressure elastic part 312 and the meandering movement preventing part 314 to the belt restricting surface 366a, 366b is referred to as LS.

Since the fixing belt 320 should be configured to enable the meandering movement, it may satisfy the following relationship:

LB<LF.

Further, when the fixing belt 320 is biased to the one side by the meandering movement, the fixing belt 320 should not deviate from the belt rotation guide 362, and thus it may satisfy the following relationship:

LL<LB.

If the fixing belt 320 is biased to the one side by the meandering movement, a surface area on which the first meandering movement preventing part 314a is in contact with the fixing belt 320 is increased, and a surface area on which the second meandering movement preventing part 314b is in contact with the fixing belt 320 is reduced, and thus it may satisfy the following relationship:

LF≦LPC+2×LPE and LS≦LPE. In such conditions, when the fixing belt 320 is biased to one side and in contact with the first belt restricting surface 366a, the frictional force between the fixing belt 320 and the first meandering movement preventing part 314a becomes maximum. In the other side of the fixing belt 320 which is opposite to the biased side, a contact area with the second meandering movement preventing part 314b is reduced, and thus the frictional force is also reduced. If it may satisfy the relationship of LB<LS+LPC, the other side of the fixing belt 320 is not in contact with the second meandering movement preventing part 314b, and the frictional force at the first meandering movement preventing part 314a becomes maximum.

On the contrary, when the fixing belt 320 is biased to other side and in contact with the second belt restricting surface 366b, the frictional force at the second meandering movement preventing part 314b is increased, and the frictional force at the first meandering movement preventing part 314a is reduced.

Hereinafter, an image fixing device and an image forming apparatus having the same according to an embodiment will be described. In an embodiment, the description overlapping an embodiment in FIG. 1 will be omitted.

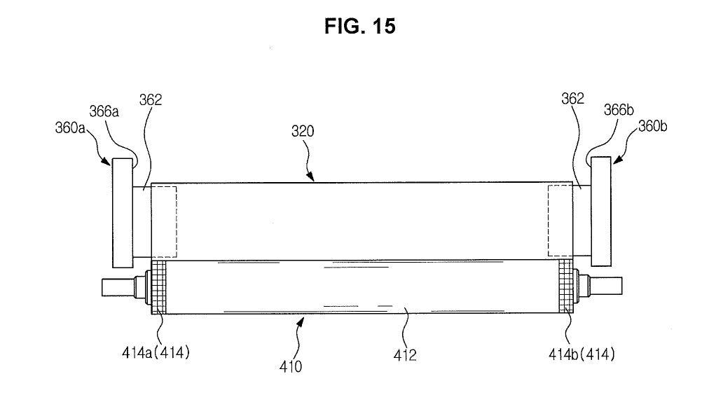

FIG. 15 is a front view of an image fixing device according to an embodiment.

In an embodiment, a pressure roller 410 may be formed to be shorter than the pressure roller 310 of the fourth embodiment. Specifically, a pressure elastic part 412 and a meandering movement preventing part 414 may have a short length and thus a distance between the first belt restricting surface 366a and the second belt restricting surface 366b may shorten.

That is, it may satisfy the following relationship:

LPC+2×LPE<LF.

In an embodiment, if a relationship of LS+LPC+LPE>LB is satisfied, a surface area on which a first meandering movement preventing part 414a is in contact with the fixing belt 320 is increased, and a surface area on which a second meandering movement preventing part 414b is in contact with the fixing belt 320 is reduced, when the fixing belt 320 is biased to the one side by the meandering movement.

In the above description, for convenience of explanation, the fixing belt which is biased to the one side has been described, but the fixing belt which is biased to the other may also be applied. Further, in one or more embodiments, the meandering movement preventing part formed on each of the inner and outer circumferential surface of the fixing belt and the outer circumferential surface of the pressure roller has been described, but the plurality of embodiments may be applied together.

According to the image fixing device and the image forming apparatus having the same, since the meandering movement of the fixing belt may be restricted, it is possible to enhance a lifespan of the fixing belt and image forming quality.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. An image fixing device comprising:
a fixing belt configured to be rotatable; and
a pressure roller which is disposed to be opposite to the fixing belt and thus to press an outer circumferential surface of the fixing belt;
wherein the fixing belt comprises:
a fixing part which has an outer surface having a first friction coefficient μo1; and
a meandering movement preventing part which is located at each of both ends of the fixing part in a length direction of the fixing belt, and which has an outer surface having a second friction coefficient μo2 which is greater than the first friction coefficient μo1.

2. The image fixing device according to claim 1, wherein:
the meandering movement preventing part comprises:
a first meandering movement preventing part disposed at one end of the fixing belt; and
a second meandering movement preventing part disposed at the other end of the fixing belt, and
when the fixing belt is biased to the one end, a surface area on which the first meandering movement preventing part is in contact with the pressure roller is reduced.

3. The image fixing device according to claim 1, wherein:
the meandering movement preventing part comprises:
a first meandering movement preventing part disposed at one end of the fixing belt; and
a second meandering movement preventing part disposed at the other end of the fixing belt, and
when the fixing belt is biased to the one end, a surface area on which the second meandering movement preventing part is in contact with the pressure roller is increased.

4. The image fixing device according to claim 3, wherein, when the fixing belt is biased to the one end, a frictional force generated at the second meandering movement preventing part is greater than that generated at the first meandering movement preventing part.

5. The image fixing device according to claim 1, wherein the meandering movement preventing part has a higher roughness than that of the fixing part.

6. The image fixing device according to claim 1, wherein:
the fixing belt comprises:
a supporting body;
an elastic layer provided on an outer circumferential surface of the supporting body; and
a release layer provided on an outer circumferential surface of the elastic layer and having the fixing part formed therein, and
the meandering movement preventing part is provided so that at least a part of the release layer is removed and the elastic layer is exposed to an outside.

7. The image fixing device according to claim 1, wherein the meandering movement preventing part is formed by coating both ends of the fixing belt with a high frictional material having the second friction coefficient μo2.

8. The image fixing device according to claim 7, wherein the meandering movement preventing part formed of the high frictional material has a larger diameter than that of the fixing part.

9. The image fixing device according to claim 1, wherein:
the fixing belt comprises:
a passing part through which a printing medium passes between the fixing belt and the pressure roller; and
a non-passing part through which the printing medium does not pass, and
the meandering movement preventing part is formed at the non-passing part.

10. The image fixing device according to claim 1, further comprising a belt guide which comprises a belt restricting surface restricting a length directional movement of the fixing belt, and which is disposed at each of length directional both ends of the fixing belt.

11. The image fixing device according to claim 10, wherein:
the belt restricting surface comprises:
a first belt restricting surface disposed at one end of the fixing belt; and
a second belt restricting surface disposed at the other end of the fixing belt,
the pressure roller comprises a pressure elastic layer provided to be in contact with the fixing belt, and
a distance LF between the first belt restricting surface and the second belt restricting surface and a length LP from one end of the pressure elastic layer to the other end thereof satisfy the following relationship:
LP<LF.

12. The image fixing device according to claim 11, wherein the distance LF between the first belt restricting surface and the second belt restricting surface, a length LB from one end of the fixing belt to the other end thereof, and a length LR of a space allowing the fixing belt to be movable in a length direction satisfy the following relationship:
LF=LB+LR.

13. The image fixing device according to claim 11, wherein a length LBC between one end of the fixing part and the other end thereof, a length LBE between one end of the meandering movement preventing part and the other end thereof, and a distance LS between one end of the pressure elastic layer and the first belt restricting surface satisfy the following relationship:
LBC+LBE<LP+LS.

14. The image fixing device according to claim 11, wherein a length LBC between one end of the fixing part and the other end thereof satisfies the following relationship:
LBC<LP.

15. The image fixing device according to claim 11, wherein a length LBC between one end of the fixing part and the other end thereof and a length LBE between one end of the meandering movement preventing part and the other end thereof satisfy the following relationship:
LP<LBC+2*LBE.

16. The image fixing device according to claim 11, wherein a length LBE between one end of the meandering movement preventing part and the other end thereof and a distance LS between one end of the pressure elastic layer and the first belt restricting surface satisfy the following relationship:
LBE<LS.

17. The image fixing device according to claim 11, wherein a length LBC between one end of the fixing part and the other end thereof, a length LBE between one end of the meandering movement preventing part and the other end thereof, and a distance LS between one end of the pressure elastic layer and the first belt restricting surface satisfy the following relationship:
2*LBE+LBC<LP+LS.

18. The image fixing device according to claim 1, wherein the fixing belt further comprises:
a surface to be pressed, which is provided at an inner surface of the fixing part so as to have a third friction coefficient; and
an internal meandering movement preventing surface which is disposed at each of both ends of a part to be pressed, in the length direction of the fixing belt, and formed at an inner circumferential surface of the fixing belt so as to have a fourth friction coefficient less than the third friction coefficient.

19. An image fixing device comprises:
a fixing belt which is in contact with a printing medium having a non-fixed image so as to transfer heat and which is configured to be rotatable; and
a pressure roller disposed to be in pressure contact with an outer circumferential surface of the fixing belt,
wherein the pressure roller comprises:
a pressure elastic part provided to press the fixing belt; and
a meandering movement preventing part located at both ends of the pressure elastic part in a length direction of the pressure roller and formed on an outer circumferential surface of the pressure roller to have a different friction coefficient from that of the pressure elastic part.

20. An image fixing device comprises:
a pressure roller configured to be rotatable;
a fixing belt disposed on an outer circumferential surface of the pressure roller to be in contact with the pressure roller; and
a pressure member disposed in the fixing belt to press the fixing belt toward the pressure roller,
wherein the fixing belt comprises:
a fixing part having a surface to be pressed, which is provided on an inner surface thereof to be pressed by the pressure member; and
a meandering movement preventing part having a meandering movement preventing surface provided on an inner surface thereof and located at both ends of the fixing part in a length direction of the fixing belt.

21. The image fixing device according to claim 20, wherein the fixing part further comprises a fixing surface provided on an outer surface thereof,
the fixing surface is in contact with the pressure roller, and
the surface to be pressed and the meandering movement preventing surface are in contact with the pressure member.

22. The image fixing device according to claim 21, wherein a friction coefficient μo of the fixing surface, a friction coefficient μi1 of the surface to be pressed, and a friction coefficient μi2 of the meandering movement preventing surface satisfy the following relationship:
μo>μi1>μi2.

23. The image fixing device according to claim 20, wherein:
the surface to be pressed has a first friction coefficient μi1, and
the meandering movement preventing surface has a second friction coefficient μi2 which is less than the first friction coefficient μi1.

24. The image fixing device according to claim 23, wherein the meandering movement preventing surface is formed by coating the both ends of the inner circumferential surface of the fixing belt with a low frictional material having the second friction coefficient μi2.

25. The image fixing device according to claim 20, wherein the meandering movement preventing part comprises:
a first meandering movement preventing part disposed at one end of the fixing belt; and
a second meandering movement preventing part disposed at the other end of the fixing belt, and
when the fixing belt is biased to the one end, a surface area on which the first meandering movement preventing part is in contact with the pressure roller is reduced.

26. The image fixing device according to claim 20, wherein:
the meandering movement preventing part comprises:
a first meandering movement preventing part disposed at one end of the fixing belt; and
a second meandering movement preventing part disposed at the other end of the fixing belt, and
when the fixing belt is biased to the one end, a surface area on which the second meandering movement preventing part is in contact with the pressure roller is increased.

27. An image forming apparatus comprising the image fixing device according to one of claim 1.

28. An image forming apparatus comprising the image fixing device according to one of claim 19.

29. An image forming apparatus comprising the image fixing device according to one of claim 20.
